(19) United States
(12) Patent Application Publication
(10) Pub. No.: US 2009/0023477 A1
(43) Pub. Date: Jan. 22, 2009

(54) METHOD AND APPARATUS FOR RECONFIGURING A MULTI-SECTOR BASE STATION

(75) Inventor: Donald STAUDTE, Huddinge (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 12/118,316

(22) Filed: May 9, 2008

Related U.S. Application Data
(60) Provisional application No. 60/950,739, filed on Jul. 19, 2007.

(51) Int. Cl. H04M 1/00

(52) U.S. Cl. 455/562.1

(57) ABSTRACT

A method and apparatus are described for reconfiguring a multi-sector base station. A first sector is configured to provide coverage for a first sector area and has first corresponding radio communications equipment connected to a first antenna with variable horizontal beamwidth and direction. A second sector is configured to provide coverage for a second sector area and has second corresponding radio communications and antenna equipment. When an indication is detected to reconfigure the base station apparatus from a first base station configuration to a second base station configuration, the horizontal beamwidth and direction of the first antenna are adjusted to provide coverage both for the first sector area and for the second sector area. Example applications of this technology include situations when there is radio equipment failure in a sector, overload of existing radio equipment, a desire to go to power savings operation, or some other sort of shutdown in a sector.

### PRIORITY

This application claims priority from U.S. provisional application 60/950,739, filed on Jul. 19, 2007, the contents of which are incorporated herein by reference.

### RELATED APPLICATIONS

This application relates to commonly-assigned, U.S. patent application Ser. No. 11/607,082, filed Dec. 1, 2006, and Ser. No. 11/798,921, filed May 17, 2007.

### TECHNICAL FIELD

The technical field relates to multi-sector base stations. The reconfigurable multi-sector base station described below provides radio coverage in a geographical area of a radio communications system containing multiple base stations. Non-limiting example applications include when there is a radio equipment failure or a need for maintenance in that sector. Another example application is when a power savings mode of operation is desirable.

### BACKGROUND

An omni-base station is a base station that is configured to use an omni-antenna, and a sector base station is configured to use multiple (two or more) sector antennas. FIG. 1A shows the coverage area for a base station (BS) with an omni-antenna, with the 360 degree radiation pattern of the omni-antenna visible. FIG. 1B shows the coverage area for a 3-sector base station (more or less sectors could be used). In the 3-sector case, the coverage area is divided into thirds, with each sector antenna providing coverage over its sector area. Other sector sizes are possible.

A sector defines a geographical area in which certain multiple access resources (such as frequencies for GSM, or codes for WCDMA) are available. There can also be handovers between sectors. Multiple sectors provide increased base station capacity compared to the omni case because the resources may be reused more often. The directivity of sector antennas permits minimizing interference between radio signals to/from users located in different sectors, which increases base station capacity. High directivity also increases antenna gain which allows a multi-sector base station to cover a larger area than an omni-base station.

A radio network usually covers a large geographical area and uses multiple base stations to provide that coverage. The base stations are deployed with sectors according to a cell plan for providing desired services, avoiding dropped calls as users move from one region to another, and avoiding unnecessary interference between neighboring sectors. A cell plan's overall coverage pattern may be constructed with each base station cell (sector) coverage area, or each base station coverage area being often modeled by a hexagon.

In general, one or more sets of radio equipment including transceivers and the like, located in the base station, are used per sector. Multi-sector base stations provide full coverage by having at least one set of radio equipment working in each and every sector all of the time. Unless at least one set of radio equipment operates continuously in each sector, there will be a loss of coverage in that sector area, i.e., no calls can be initiated or maintained by the users in that area. Normally, only patchy coverage near the sector borders would be available from neighboring sectors, due to the cell plan being optimized to reduce interference via minimal overlap between sectors.

The requirement for coverage leads to large operational costs for the operator. Operational costs include: high power consumption at the base station, high maintenance costs as O&M personnel must be on standby to travel to base stations to fix radio equipment failures, and customer dissatisfaction when equipment failure leads to coverage loss. Operators are often forced to schedule activities at night-time to minimize traffic loss. Such activities which normally require radio equipment shutdown include on-site or remote maintenance, testing or upgrades, of either radio equipment or parts of the antenna subsystem.

Traffic varies considerably during the day within the network. But even during periods of low traffic, the power consumption of the network can only be reduced to the level needed to continuously operate one radio equipment in each and every sector. A key characteristic of RF power amplifiers is that their efficiency is highest when operating at their maximum output power, so that at low loads a relatively large amount of power is consumed with little return. The minimum power consumption of a radio network providing coverage during low traffic may be related to the number of RF power amplifiers in operation, which in turn depends on the number of sectors. Low traffic periods can be quite lengthy (e.g., all night long), so the total power consumption during these periods is significant.

Even though there are often periods when the traffic volume is low, multi-sector base stations must have sufficient capacity to satisfy high demands during time periods of peak traffic volume. High capacity could be deployed in a sector by multiple sets of radio equipment. Although the power costs for additional equipment are significant, some of the additional sets of equipment may be shutdown, and the extra sets of radio equipment provide redundancy against failures. Multiple sets of radio equipment have additional costs including multiple antennas and/or high power combining with associated loss of signal strength; extra power supply, space and cooling requirements. There are many situations where only one radio equipment per sector is used. It is common that peak traffic volumes are much lower in more sparsely populated areas of a radio network, and in these areas, one radio equipment per sector is often sufficient. There is a trend towards Multi-Carrier Power Amplifiers (MCPAs) with high output power. A single MCPA can accommodate a high traffic volume. In a roll-out situation, one radio equipment per sector may be deployed to reduce the initial investment cost. It would be desirable to provide a multi-sector base station arrangement that can provide the needed capacity but also use less energy during periods of low traffic. One way to do this is to shut down more sets of radio equipment so that less than one set of radio equipment per sector is used.

One possible approach to reduce the number of radio equipments in operation to below one per sector is by switching one set of radio equipment to simultaneously feed all the antennas in two or more sectors via a splitter/combiner or Butler Matrix. In effect, the signal is split on the downlink and combined on the uplink. But this approach suffers from performance problems arising from the difficulty of attempting to optimize both the starting and final configurations with the same antenna system and hence cell plan. If the same signal is sent through antennas in adjacent sectors on the downlink, there may be areas of destructive interference at the border between these sectors that otherwise do not appear when different signals reach the same user. Also, if a single radio equipment fails, then simply switching an adjacent sector to cover both sectors only makes use of one, rather than all the other neighboring sectors to help alleviate the coverage hole. While the antenna gain remains the same in a Butler matrix solution, the downlink output power per sector is reduced due to the splitter. For example, a split to three sectors implies 5 dB less output power per sector. Similarly, the uplink sensitivity is often reduced (an average of 5 dB for 3-sectors) due to combining. It is also necessary to supply power and communication to equipment such as TMAs in the antenna system independently of the radio equipment, which increases costs.

### SUMMARY

Even though sector radio equipment together with its sector antenna subsystem are configured to operate only in one sector, the inventor recognized that significant benefits can be achieved by sharing that sector radio equipment together with its antenna subsystem with two or more sectors, e.g., in a remotely-controlled fashion. As a result, the coverage loss and other problems associated with shutting down radio equipment and its antenna subsystem in one sector can be significantly alleviated by switching to a backup configuration where the radio equipment and its antenna subsystem for another sector is reconfigured to provide coverage for both sectors. One sector can also be reconfigured to cover in addition one or more other sector areas during low traffic demand time periods, so that the radio equipment of those other sector areas can be powered down to conserve power. Although there are many different applications for this technology, non-limiting examples include a radio equipment failure in a sector, power saving operation in a sector during low traffic time periods, or an upgrade or maintenance of a sector.

In this way, less than one radio equipment per (original) sector is achieved. To address resulting coverage and capacity (also bit rate) issues, the cell plan of the entire or a part of the radio network is changed to minimize negative impacts on capacity and coverage when there is less than one radio equipment in operation in each sector. A first sector is configured to provide coverage for a first sector area and has first corresponding radio communications equipment and a first antenna subsystem containing a first antenna with variable beamwidth and variable beam direction. A second sector is configured to provide coverage for a second sector area and has second corresponding radio communications equipment and a second antenna subsystem containing a second antenna with variable beamwidth and variable beam direction. When an indication is detected to reconfigure the base station apparatus from a first base station configuration to a second base station configuration, the configuration of first radio communications equipment and first antenna subsystem is adjusted to provide coverage both for the first sector area and for the second sector area. When a need is detected to reconfigure the base station apparatus from the second base station configuration to the first base station configuration, the first radio communications equipment and its antenna subsystem may be adjusted to provide coverage for just the first sector area and activate the second radio communications equipment and the second antenna subsystem to provide coverage for its second sector area. Similarly, if the radio base station apparatus includes a third sector configured to provide coverage for a third sector area and having third radio communications equipment and a third antenna subsystem containing a third antenna with variable beamwidth and variable beam direction, the first radio communications equipment may be adjusted to provide coverage for the first, second, and third sector areas in response to the need to reconfigure the base station apparatus. This technology extends to situations where multiple sector radio equipments in a plurality of base stations in the network are shut down, and multiple sector radio equipments and antenna subsystems are adjusted to provide a new cell plan optimal for the new distribution of sector radio equipment remaining in operation.

An example reconfiguration indication is a predetermined condition or parameter indicating a need or request for reconfiguring the base station apparatus such as the time of day, a sector load, a radio condition, a malfunction, a maintenance need, or an upgrade affecting the second sector. The reconfiguration indication can also include a notification from a supervisory node external to the base station. The second sector radio communications equipment may be powered-down in order to save power when the configuration of first radio communications equipment is adjusted to provide coverage both for the first sector area and for the second sector area. Alternatively, the second sector radio communications equipment may need to be serviced, may have suffered a malfunction, or has to be shutdown for some other reason.

The sector antenna subsystem is coupled to the radio equipment for each sector and includes a remotely reconfigurable antenna, e.g., an antenna with variable beamwidth and/or variable beam direction. That remote reconfigurability may be accomplished in a variety of ways such as by changing the angle of reflectors and/or adjusting the phase shift of the antenna elements to alter the antenna's horizontal beamwidth. Reconfigurability also includes rotating the horizontal beam direction (for example by rotating the elements and reflectors or by using lenses) and/or adjusting vertical tilt of the antenna by electrical phase shift. Such reconfigurability may be achieved remotely by sending control signals to the antenna subsystem via the base station and feeder cables or via an external controller.

During shutdown of all operating radio equipment in a single sector, the horizontal beamwidth of an adjacent sector antenna may be (remotely) increased to provide coverage. In addition, the horizontal beam direction may be altered to redirect the coverage pattern to cover both the original and shutdown sectors. Furthermore, the beamwidths and beam directions of neighboring sectors may also be adjusted to compensate for coverage and capacity loss resulting from shutting down sector equipment and using a widened beam. Adjustments to the performance of radio equipment may also be made. When shutdown radio equipment is taken back into operation, the beamwidths and beam directions of adjusted antennas, plus the performance settings of the radio equipments are returned to normal.

When there is a shutdown of multiple radio equipments in the network in low traffic volume situations in order to save power, the cell plan is adjusted by widening beams, adjusting beam directions, and/or altering performance of remaining radio equipments in operation. The amount of shut down radio equipment is preferably matched to the actual reduced traffic load. Reduced traffic load minimizes interference and reduces the need for tighter reuse which is beneficial when some sectors are not operating their normal sector radio equipment. In one non-limiting application, broadcast channel (e.g., BCCH) frequencies are allocated in a suitable manner to support adjusted cell plans (e.g., in a GSM-based system).

### BRIEF DESCRIPTION OF THE DRAWINGS

FIG. 1A shows the coverage area for a base station (BS) with an omni-antenna;

FIG. 1B shows the coverage area for a base station (BS) with three sector antennas;

FIG. 2A shows a base station tower;

FIG. 2B shows a base station tower with tower-mounted amplifier (TMA);

FIG. 3 shows a simplified block diagram of an non-base station;

FIG. 4 is a function block diagram showing a non-limiting example of an N sector, reconfigurable base station;

FIG. 5 is a flowchart diagram illustrating non-limiting example procedures for reconfiguring a multi-sectored base station;

FIG. 6 is a diagram illustrating an example reconfiguration of a six-sector base station to a three-sector base station;

FIG. 7 is a diagram used to explain coverage for six- and three-sector geometries;

FIG. 8 is a flowchart diagram illustrating non-limiting example procedures for reconfiguring a multi-sectored base station coupled with an associated cell coverage plan;

FIG. 9 shows the effect of the reduced antenna gain when the beamwidth is doubled;

FIGS. 10-12 show three non-limiting example methods to arrange sector directions in a hexagonal model 6-sector network;

FIG. 13 shows an intermediate configuration including fully operational 6-sector sites plus 6-sector sites with 3-sectors shutdown;

FIG. 14 is a diagram illustrating an example reconfiguration of a three-sector base station to a two-sector base station;

FIG. 15 illustrates a non-limiting example of a cell plan that accommodates a power saving base station reconfiguration for a network of three-sector base stations in which two sectors of each base station together provide coverage for all three sectors;

FIG. 16 shows an omni pattern in which all radio equipments except one to be shut down in a multi-sector base station in a power saving mode;

FIG. 17 illustrates a non-limiting example method to avoid a radiated pattern from being disturbed by other antennas;

FIG. 18 shows a non-limiting example of BCCH planning for a 6-sector configuration; and

FIG. 19 shows a non-limiting example of BCCH planning for a 3-sector configuration.

FIGS. 20 and 21 show how the distance that adjustable antennas are placed from the mast center affects the maximum angle for free radiation for the 6-sector and 3-sector starting configurations, respectively; and

FIGS. 22-25 show four non-limiting example configurations where nearby sectors are adjusted to cover a single shutdown sector.

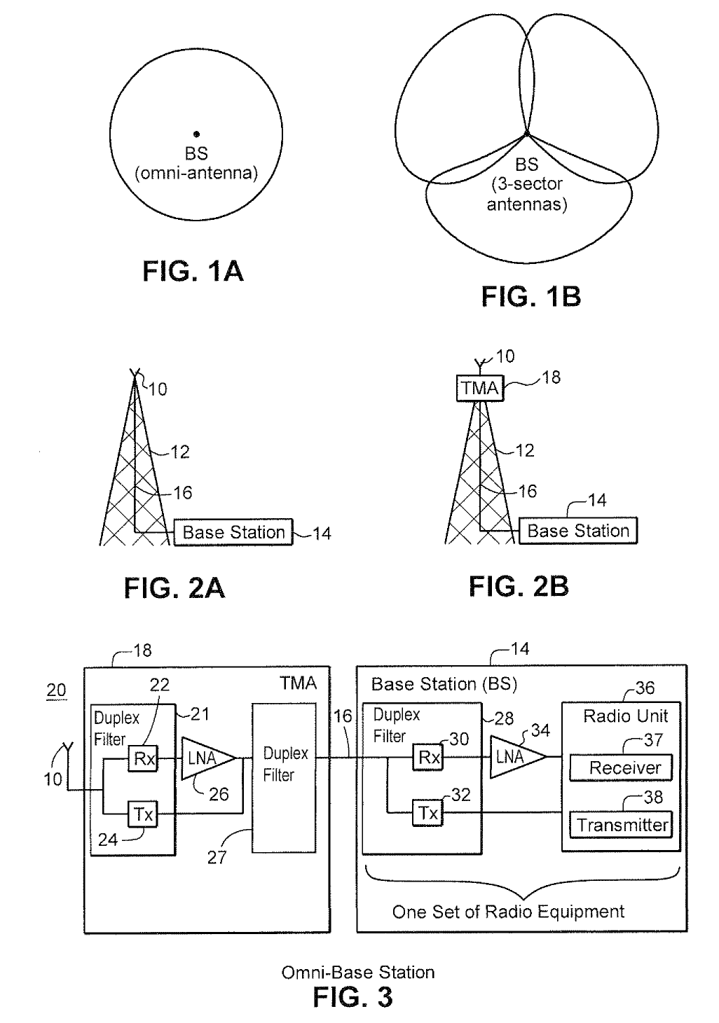

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs).

A base station antenna is often mounted in an elevated location, such as on a tower, a pole, on the top or sides of buildings, etc., to enhance coverage and provide better possibilities for direct radio signal propagation paths. FIG. 2A shows a base station unit 14 located at the base of a tower 12. An antenna 10 is mounted on the top of the tower 12 and is connected via a feeder cable 16, typically a coaxial cable or the like, to the base station transceiver. The received signal suffers signal losses traversing the feeder 16, and the taller the tower 12, the longer the feeder, and the greater the loss. In order to offset such signal losses in the feeder, a tower-mounted amplifier (TMA) may be used to amplify the received signal before it is sent over the feeder to the base station unit. FIG. 2B shows a TMA 18 mounted at the top of the tower 12 near antenna 10. A tower mounted amplifier is sometimes called a mast head amplifier.

FIG. 3 shows a simplified block diagram of an omni-base station 20. The antenna 10 is connected to a duplex filter 21 in the TMA 18 which includes a receive (Rx) filter 22 and a transmit (Tx) filter 24. The receive filter is coupled to a low noise amplifier (LNA) 26, and another similar duplex filter 27 is located on the other side of the LNA 26. The duplex filters makes it possible to send and receive on the same antenna and share the same coax feeders, while allowing separation of transmitter and receiver parts as needed in the base station and TMA. The TMA 18 is coupled to a feeder 16 to the base station 14 which also includes a duplex filter 28 having a receive filter (Rx) 30 and a transmit (Tx) filter 32. The transmit filter 32 is connected to a radio unit/transceiver 36 that includes a receiver 37 and a transmitter (containing an RF power amplifier) 38, and the receive filter 30 is connected to the radio unit 36 via a low noise amplifier 34. The duplex filter 28, the LNA 34, and the transceiver radio unit 36 are an example of one set of radio equipment. Antenna diversity may be used in order to improve reception (or transmission) of transmitted radio signals.

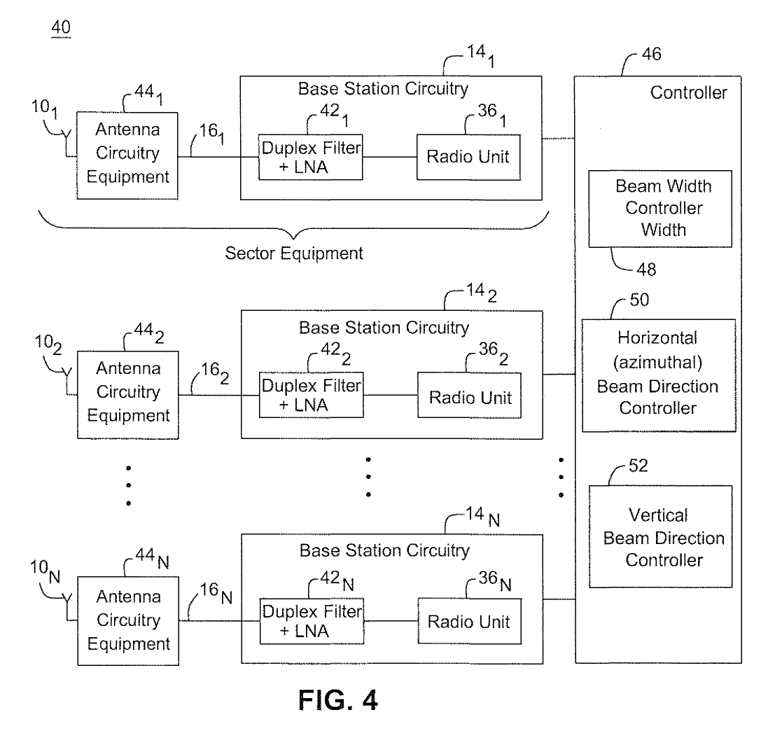

FIG. 4 is a simplified block diagram of a multi-sector base station 40 shown with N sectors. Although N may be any positive integer, typical example values for N are 3 and 6. In normal, fill capacity operation, each base station sector 1, 2, . . . , N is associated with its own geographical coverage area sometimes called a cell. Each base station sector 1, 2, . . . , N includes its own antenna 10₁, 10₂, . . . , 10_{N}, antenna circuitry/equipment 44₁, 44₂, . . . , 44_{N}, that preferably (but not necessarily) includes antenna adjustment circuitry and TMA circuitry, and base station circuitry 14₁, 14₂, . . . , 14_{N}. The base station circuitry 14 may include, as an example, a duplex filter and low noise amplifier 42 and a radio unit (transmitter and receiver) 36. For convenience and as an example shown for the first sector in FIG. 4, the term “sector equipment” refers to all of the antenna equipment and all sets of radio equipment for each sector. Furthermore, the term “base station circuitry” refers to all sets of radio equipment in a sector. In FIG. 4, the base station circuitry includes one set of radio equipment. The base station circuitry 14₁, 14₂, . . . , 14_{N} is connected to a controller 46, which includes among other things, a beamwidth controller 48, a horizontal antenna beam direction controller 50, and a vertical antenna beam direction controller 52. The controller 46 may be a part of the base station control unit or located remotely from the base station. Signals to request the controller 46 to adjust the relevant antennas may be sent, for example, from a Network Operation Center (not shown) via a transmission link with the base station 40. Alternatively, the controller 46 may be remote from the base station 40, e.g., at a network operation center, and signals to adjust the antennas are sent transparently via the base station through the base station circuitry in the relevant sector(s).

The antenna 10 and antenna circuitry/equipment 44 for a sector is referred to as an antenna subsystem. The antenna adjustment circuitry 44 may include one or more remotely-controllable motors for adjusting the horizontal direction of the antenna beam and/or tilting the vertical direction of the antenna beam. The horizontal (azimuthal) antenna controller 50 may be used to control a motor for adjusting the horizontal direction of the antenna beam. The vertical beam direction controller 52 may be used to control a motor for adjusting the vertical tilt of the antenna beam. Non-limiting examples of remotely-adjustable antennas include those offered for sale by KMW Inc. An “antenna subsystem” may also include other equipment such as TMAs, Smart Bias-Ts, feeder cables, diplexers, combiners, etc. for that sector. The radio equipment in the base station for a given sector is coupled to the antenna subsystem for that sector. An antenna system is the set of all antenna subsystems connected to a single base station.

A beamwidth controller 48 controls the width and resulting shape of the antenna beam(s) in each sector. Each antenna may include adjustable reflectors where the angle (and/or position) of the reflectors may be altered to adjust beamwidth. Alternately, or in addition, the feed system of the multiple elements inside the antenna allows adjustments to the relative phases and/or the number of excited elements in order to alter the beamwidth. An antenna subsystem having an antenna with a single feed per diversity branch may be preferred to transmit signals to the entire covered area, which is possible if the feed system within the antenna does the shaping using one input only. In contrast, multiple feed antennas require multiple radio equipments to send different beams to users in different parts of the covered area.

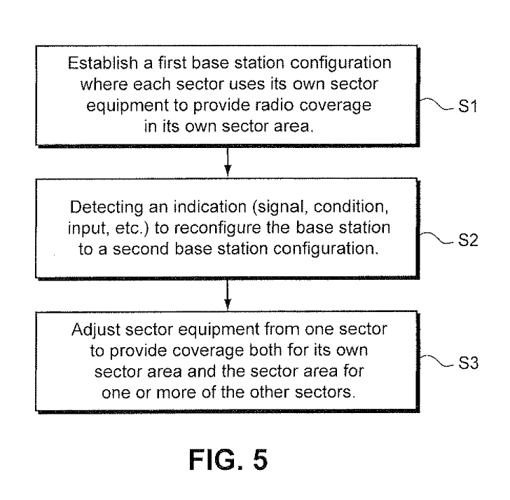

FIG. 5 is a flowchart diagram illustrating non-limiting example procedures for reconfiguring a multi-sectored base station like (but not limited to) the one shown in FIG. 4. A first base station configuration is established, e.g., a full capacity configuration, where each sector uses its own sector equipment to provide radio coverage in its own sector area (step S1). An indication is detected to reconfigure the base station to a second base station reconfiguration (step S2). The sector equipment from one sector is adjusted to provide coverage both for its own sector area and the sector area for one or more of the other sectors (step S3).

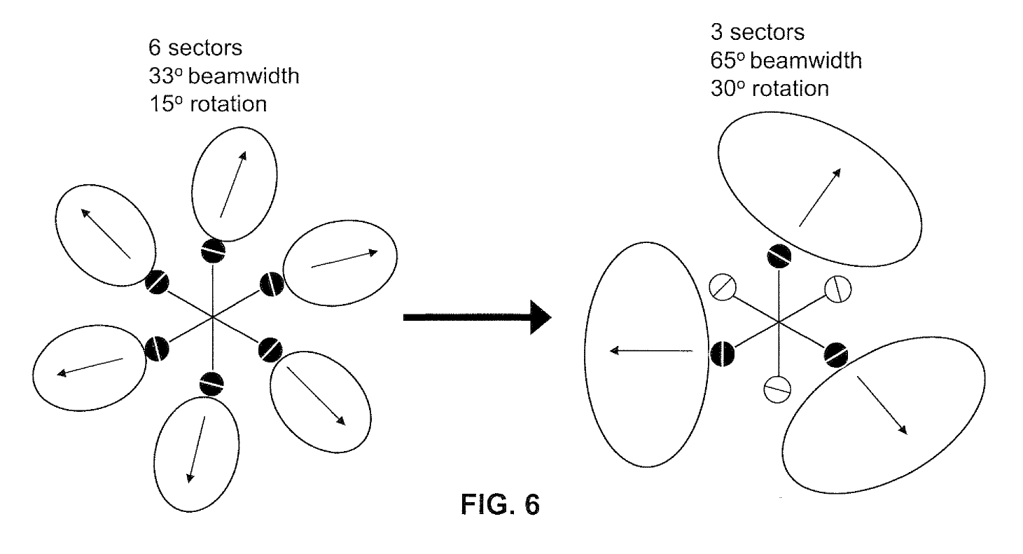

FIG. 6 is a diagram illustrating a non-limiting example reconfiguration of a single six-sector base station to a single three-sector base station. In a fill capacity configuration, each of the six sectors provides coverage in its corresponding area using its own sector equipment, with each sector's antenna subsystem covering a 33 degree horizontal (half power) beamwidth. The base station may be reconfigured to a 3-sector configuration, for example as shown, where the shaded antennas in three of the sectors are adjusted to provide a wider beamwidth, e.g., a 65 degree horizontal beamwidth, with each providing effective (though not necessarily complete) coverage for two of the six sector areas. The beamwidth controller 48 adjusts the three active sector antennas to widen the beamwidths and rotates the three active sector antennas (as indicated by the diameter line in each circle representing an antenna), e.g., 30 degrees in this example.

Switching from the 6-sector configuration to the 3-sector configuration may be done for any of a variety of reasons, a few examples of which were described in the background. One of those examples relates to saving power by turning off or powering down some of the sectors during low traffic periods. For example, the radio equipment for three of the six sectors in the base station may be powered down, e.g., remotely, from the network operator's centralized network management center, and at the same time, the operator remotely widens the beamwidth of one (or more) of the remaining antennas, and if necessary, adjusting antenna vertical tilt and/or horizontal direction so that it covers its own sector and one or more powered-down sectors as well. Adjusting the vertical tilt and horizontal direction using the vertical and horizontal antenna controllers 52 and 50 to control the necessary antenna motors, respectively, will allow the center of the single wider beam to point in the same direction as the average of the two individual sectors (if that is desired). Rather than the reconfiguration being orchestrated by a network operator or some other human entity, the reconfiguration may be triggered automatically, e.g., based on time, a sensed condition, or some other factor(s).

### Cell Plans to Optimize Coverage Over the Network

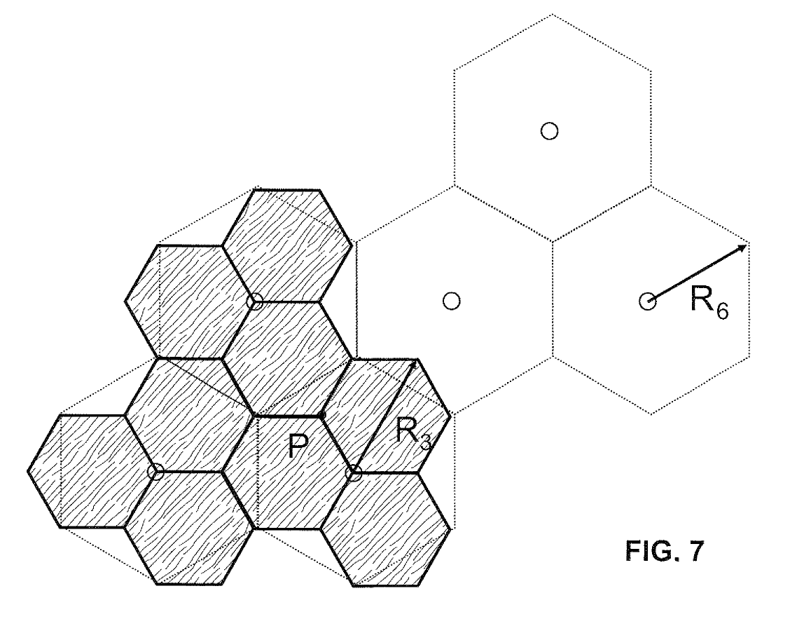

In order to significantly reduce power consumption at a network level, it is necessary to shut down radio equipments in a large percentage of the base stations in the network. As a result, adjusting the cell plan of the entire network should be considered and coordinated in each base station and antenna system on a network level. For example, consider shutting down three sectors in each base station in a network of 6-sector sites regularly placed in a hexagonal pattern. After the shutdown, three sectors remain operational for each base station preferably using the 3-sector hexagonal pattern. As can be seen in FIG. 7, neighboring site locations form the vertices of an equilateral triangle in both the 6-sector hexagonal pattern and the 3-sector hexagonal pattern. Hence it is theoretically possible to use the same regular pattern of base station locations for both 6-sector and 3-sector hexagonal cell plans. Furthermore, FIG. 7 suggests a specific rotation of non-shutdown sectors when proceeding from the 6-sector case to the 3-sector case.

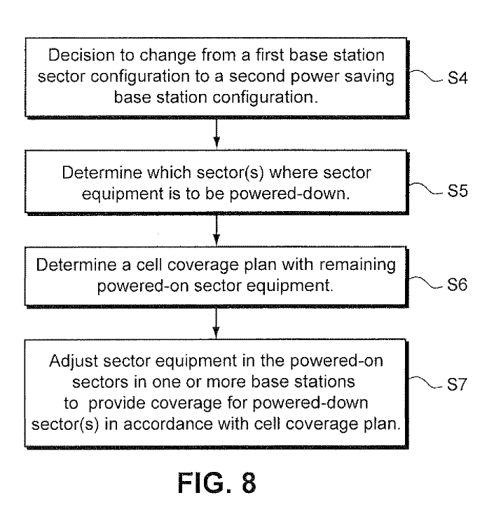

The flowchart diagram in FIG. 8 illustrates non-limiting example procedures for reconfiguring a multi-sectored base station coupled with an associated cell coverage plan. Step S4 indicates there is a decision to change from a first base station sector configuration to a second power saving base station sector configuration. Those sectors being powered down may be determined by a suitable computerized program or by personnel at the network operations center based, for example, upon expected traffic load (step S5). A cell coverage plan is determined for the remaining powered-on sector radio equipment (step S6). The radio equipment and antenna subsystem are adjusted in the powered-on sectors (e.g., via respective controllers 46) to provide coverage and/or capacity for powered-down sector areas in accordance with the determined cell coverage plan (step S7). Then the sector equipments in the sectors to be powered down are shut down.

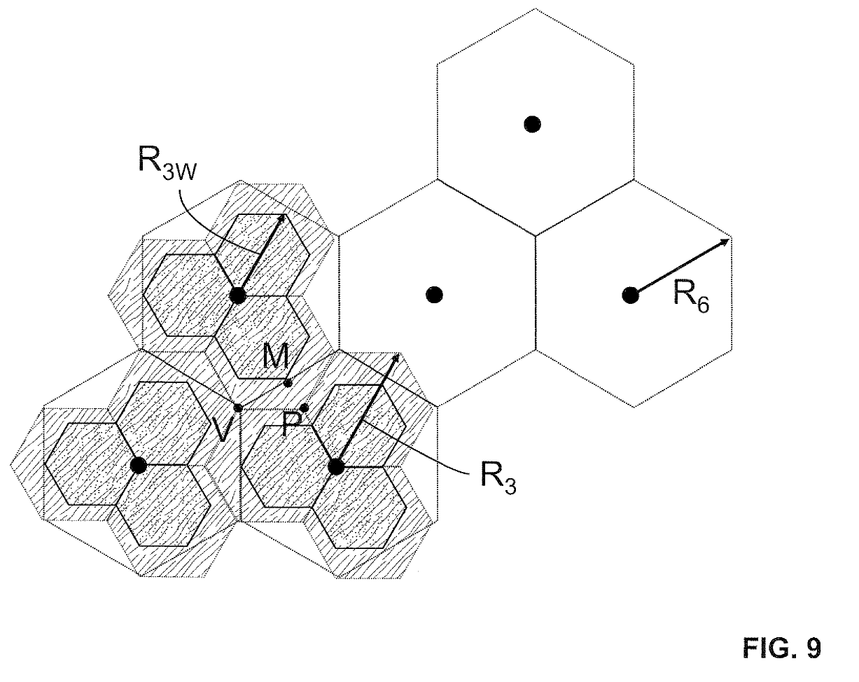

Six-sector configurations typically use antennas with a horizontal beamwidth of 33 degrees, and the (non-shutdown) antennas will have their horizontal beamwidths widened to typically 65 degrees, in order for the three active antennas to cover the area surrounding the base station in the classic 3-sector hexagonal pattern. When the beamwidth is increased, the antenna gain decreases, typically by half (or 3 dB) if the beamwidth is doubled. This is illustrated in FIG. 9. It can also be seen in FIG. 7 that the coverage from each antenna in the 3-sector cell plan (denoted R₃) must be larger than from each sector in the 6-sector cell plan (denoted R₆) if the same coverage is required. For complete coverage, (2R₆)²=3R₃². FIG. 9 shows the effect of the reduced antenna gain when the beamwidth is doubled in a 3-sector hexagonal pattern in relation to an original 6-sector grid. Coverage loss occurs in the regions of the hexagons farthest from the base station, unless other measures are taken. Widening the 6-sector antennas to 3-sector width reduces the gain by 3 dB so that R_{3W}˜2^{-1/n}R₆. For n=4, R_{3W}˜0.84R₆˜0.73R₃.

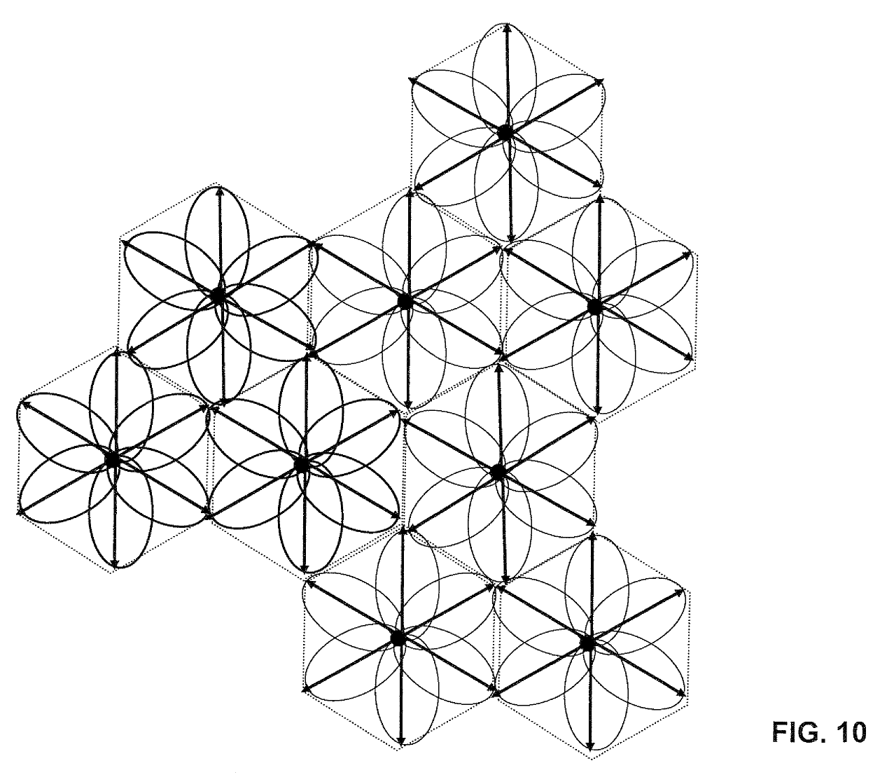

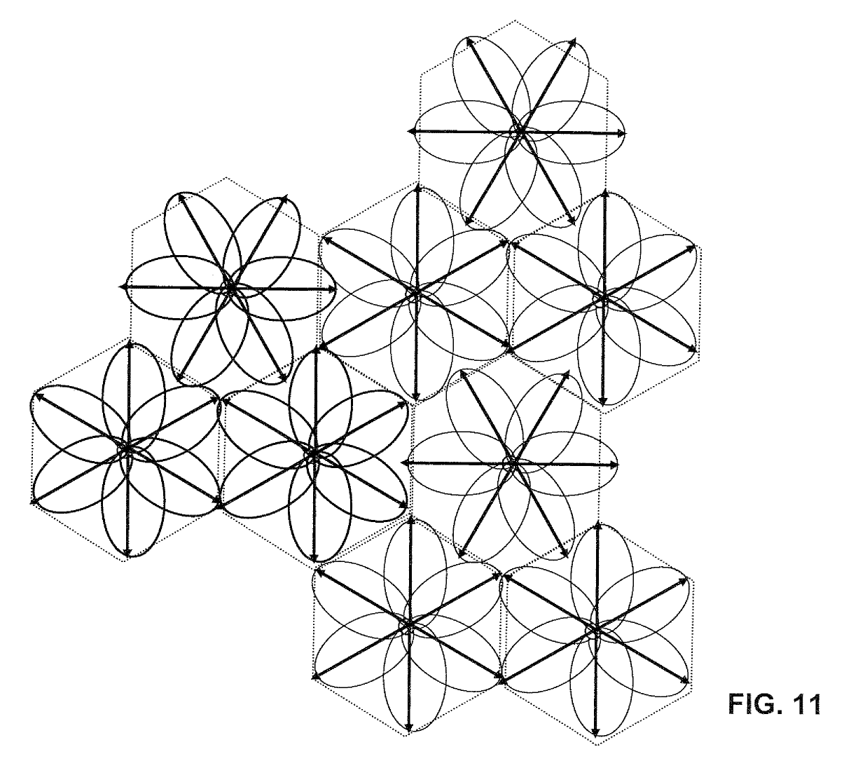

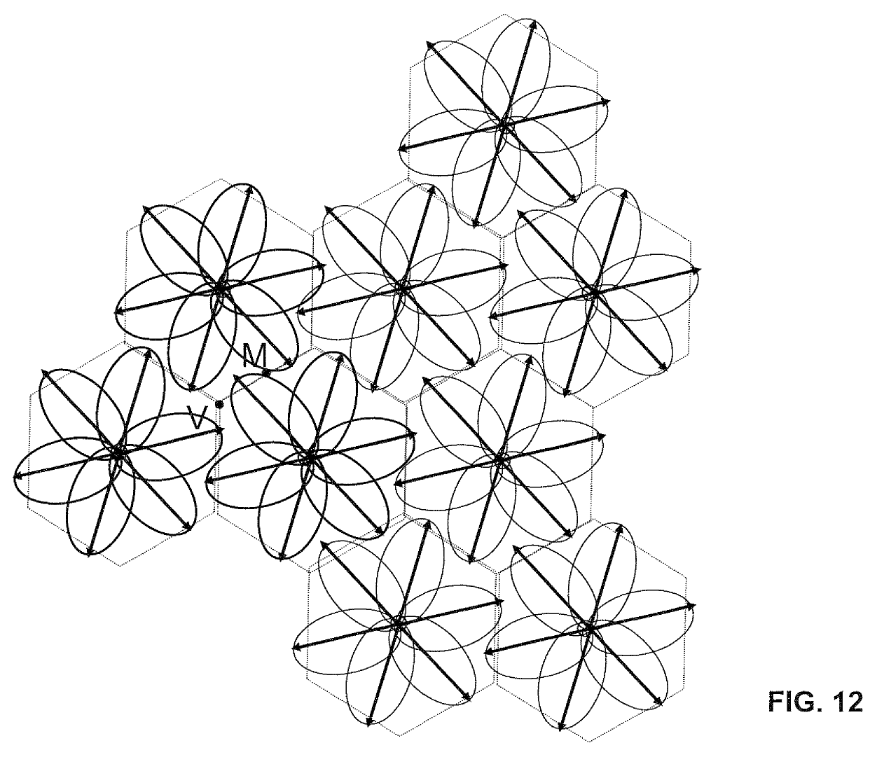

FIGS. 10-12 show three non-limiting example methods to arrange sector directions in a hexagonal model 6-sector network. FIG. 10 has sectors pointing at the hexagon vertices. Every base station has antennas pointing towards the vertices of the hexagons. FIGS. 11 and 12 have sectors directed so as to reduce interference between the centers of the antenna beams belonging to different base stations. In FIG. 11, groups of three base station sites are used. Two base stations have sectors pointed at the hexagon vertices. The third has sectors pointed at the hexagon side midpoints. The groups of 3 are repeated on the 6-sector hexagonal grid. In FIG. 12, every base station has antennas pointing halfway between the vertices and midpoints of the sides of the hexagons in a 6-sector grid.

From any of these arrangements, when three sectors in each base station are shutdown, the antenna beamwidth is widened from 33 degrees to 65 degrees for the remaining active sectors and appropriate rotation is used to obtain the pattern in FIG. 9. Because every second sector is shutdown, there is a symmetry in that in each base station, either sectors 1, 3 and 5; or sectors 2, 4 and 6 could be shutdown. This allows the operator an extra degree of freedom when choosing which sectors to shutdown.

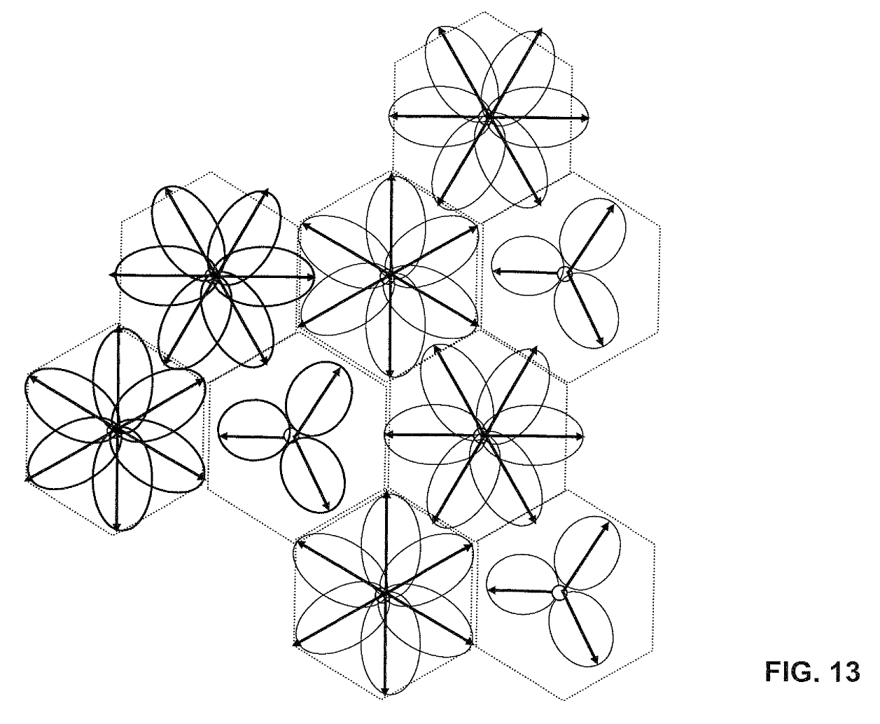

FIG. 13 shows an intermediate configuration including fully operational 6-sector sites plus 6-sector sites with 3-sectors shutdown. In each group of three base stations, sectors are arranged to minimize interference. One base station has six sectors pointed at the hexagon vertices. The second has six sectors pointed at the hexagon side midpoints. The third has three sectors pointed at the hexagon side midpoints. The groups of three are repeated on the original 6-sector hexagonal grid. This configuration could be used as a starting configuration or a final configuration or an intermediate configuration when shutting down sectors to reduce power consumption. The network configuration in FIG. 13 has more sectors in operation than if all base stations have only three active sectors, allowing the network to handle a higher traffic load.

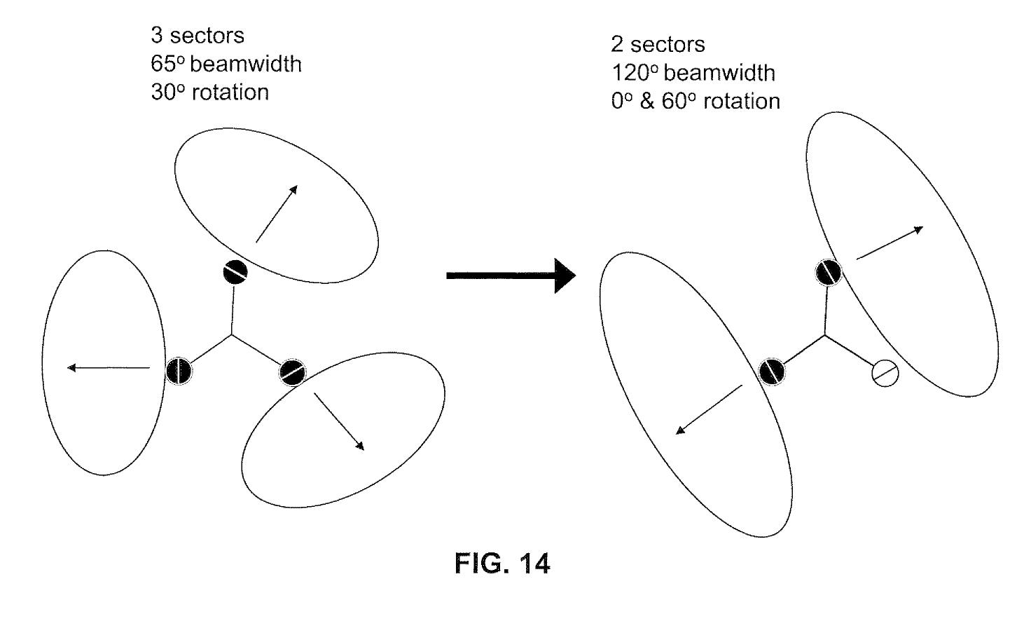

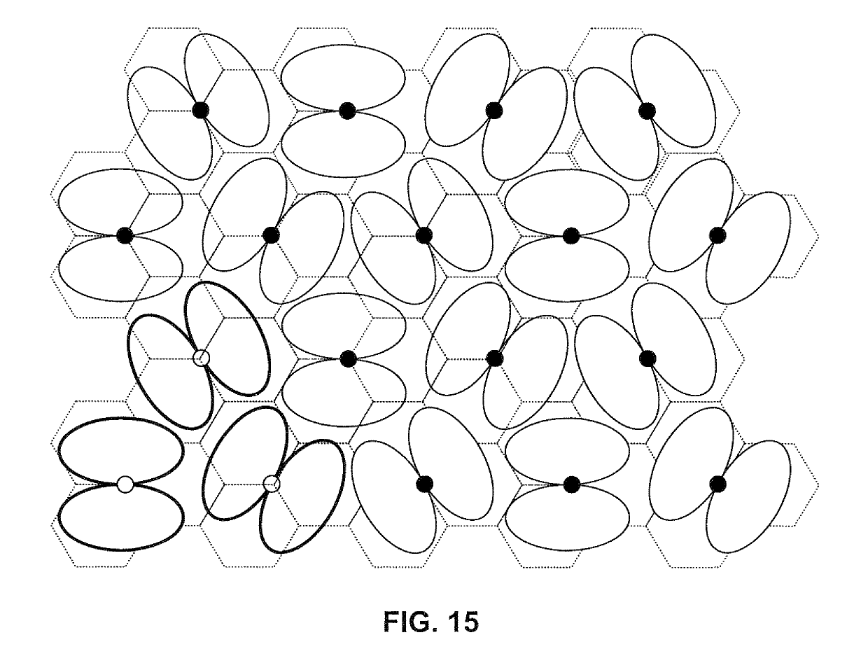

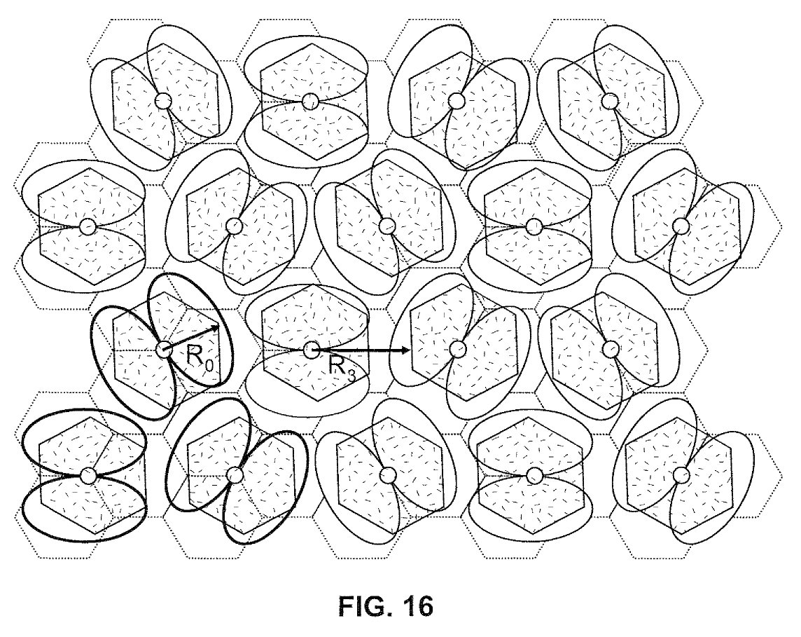

FIG. 14 is a diagram illustrating an example reconfiguration of a three-sector base station to a two-sector base station. In the example full capacity configuration, each sector antenna has a horizontal beamwidth of 65 degrees. But in the reconfigured state, one of the sectors is powered down, and the remaining two sectors must provide coverage for all three sectors. In this example, the beamwidth of those sector's antennas are increased by the beam controller 48 to 120 degrees, and the horizontal controller 50 rotates the antennas in each of those two sectors 30 degrees (a total relative rotation of 60 degrees) so that they are opposite and parallel to each other.

FIG. 15 illustrates a non-limiting example of a cell plan that accommodates a power saving base station reconfiguration for a network of three-sector base stations in which two sectors of each base station together provide coverage for all three sectors. In FIG. 15, each base station's antenna beam orientation is different from that of the immediate neighboring base station's antenna beam orientation by sixty degrees. This pattern covers the area as symmetrically as possible in order to minimize interference, retaining the site locations on the vertices of the equilateral triangles. Widening the beamwidth once again reduces the antenna gain resulting in additional coverage loss far from the base stations unless compensatory measures are implemented.

Widening the horizontal beamwidth to an omni pattern, i.e., 360 degrees, as in FIG. 16, allow all radio equipments except one to be shut down in a multi-sector base station, in a power saving mode. To avoid disturbance of the antenna beam, the widened antenna cannot radiate towards other sector antennas or the supporting tower, mast, or pole. Hence, omni antennas are normally located at the top of the tower where they can radiate freely in the entire horizontal plane. In other words, all sector antennas are preferably placed at or below a given height on a mast or tower, and an omni antenna is placed at the top of the mast or tower. A switch may then be used to controllably connect one radio equipment in the base station to the omni antenna when a signal is received to shut down all other radio equipments in the base station.

To understand the impact of coverage loss due to having fewer active sectors, each with an antenna having lower gain, it is useful to calculate the magnitude of the loss for a specific example. Consider the case of 6-sectors reducing to 3-sectors in FIG. 6, which on a network level corresponds to reconfiguring a network cell plan (see e.g., FIGS. 7 and 9). Doubling the beamwidth of an antenna leads to roughly a 3 dB loss of antenna gain. Given that both configurations cover the same area, the average loss of signal strength is estimated to be the reduction of antenna gain, i.e., approximately 3 dB. Alternatively, assuming the same output power in each operating radio equipment, the total amount of output power is half that in the 3-sector case, again suggesting an average coverage loss (on the downlink) of 3 dB.

The troublesome areas are far from the base stations, near the vertices and midpoints of the hexagons. In these regions, there are often signals from multiple sectors belonging to different base stations, and all the signals are relatively weak compared to the thermal noise floor. When connected to one sector, a terminal will treat signals from neighboring sectors either as interference or as a form of macro diversity, possibly via a handover mode. It can be seen in FIG. 9 that some of the critical areas are different in the starting and final configurations.

The vertices are the points furthest from the base stations and therefore most sensitive to loss of signal strength. A user terminal located at a vertex V in the 6-sector pattern of FIG. 12 receives signals from one sector with a beam off center by 15 degrees. This angle is slightly less than that of half of the half power beamwidth (of 33 degrees), so the relative antenna gain is just under 3 dB below maximum. The same user terminal located at the same vertex V in a network where three sectors are shutdown (see FIG. 9) receives signals from one sector with a beam off center by 30 degrees. This angle is slightly less than that of half of the half power beamwidth (of 65 degrees) so the relative antenna gain is just under 3 dB below maximum. Hence, at the vertices, a reduction in 3 dB of coverage is expected. Due to the symmetry of the patterns in FIGS. 9 and 12, it can be seen that the interference and/or macro diversity effects of the two nearest neighbor sectors also differ by 3 dB. Hence, the net effect at the vertices of reconfiguring a network from a cell plan based upon the above example is a reduction in coverage of approximately 3 dB.

The midpoints of the lines joining two neighboring vertices are closer to base stations (by a factor of sqrt(3)/2) compared to the vertices. A midpoint M in FIG. 12 obtains coverage from one sector with a relative antenna gain of roughly 3 dB below maximum. When reduced to 3-sectors (see FIG. 9), the midpoint M is covered by one sector on the beam center. In this case, the reduced antenna gain is approximately completely compensated by the user terminal being in line with the antenna beam center. In FIG. 12, the one nearest sector (in the 6-sector configuration) provides a stronger signal resulting in more interference and/or macro diversity at midpoint M than the two nearest sectors in FIG. 9 (of the 3-sector configuration). Assuming the relative gain 60 degrees off center of an antenna with 65 degrees horizontal beamwidth is 10 dB below maximum, the difference is 7 dB, when adding together the signals from the two nearest neighbor sectors in FIG. 9. This shows a positive effect when specific points originally at a maximum angle from the direction of the antenna beams become points that benefit from lying in the direction of the antenna beam.

Rather than coverage loss at the midpoints, it can be seen in FIG. 9 that coverage loss occurs moving from the midpoint M further away from the serving sector towards the point P in FIG. 9. The point P is located two thirds of the distance along the line joining two base stations bisected by the midpoint. At P, a user terminal will, in the 3-sector configuration, receive signals from all of the three nearest sectors. Assuming an r⁴ path loss distance dependence, two of these signals are roughly 10 dB and the third 12 dB weaker than the original serving sector signal in the 6-sector configuration. This shows the maximum negative effect when specific points originally within a sector become points on the sector border.

Widening a beamwidth from 65 degrees to 120 degrees will typically reduce antenna gain by 3 dB. It is possible to use a narrower beamwidth (for example 90 degrees) with roughly 1 dB higher antenna gain, but the 120 degree beamwidth improves coverage along the lines perpendicular to the 2-sector beam directions by roughly 4 dB compared to the 90 degree beamwidth. A typical omni antenna has 8 dB reduced gain compared to a 33 degree sector antenna, 5 dB compared to a 65 degree sector antenna and 2-3 dB compared to a 120 degree antenna.

The illustrated 6-sector patterns in FIGS. 10-12, the combined 6 and 3-sector pattern in FIG. 13, 3-sectors (FIG. 9), 2-sectors (FIG. 15), and omni (FIG. 16) optimally use the same grid of site locations. As a result, shutdown sequences can be considered for shutting down successively more sectors in order to save energy. Two non-limiting example shutdown sequences can be readily identified where 6-sector base stations are successively reduced to 3-sector then 2-sector then omni base stations. One example sequence is FIGS. 11->13->9->15->16 and the other is FIGS. 12->9->15->16. A sub-sequence may also be used. These sequences are chosen to minimize the changes at each successive stage of sector shutdown. The following rotation table shows which sectors are shutdown and which sectors are adjusted, and by how much. The rotation angles are measured relative to the lines originating from the center of the mast pointing radially outwards towards the 6-sector hexagon vertices

| Configuration | BS1 | BS2 | BS3 | S1 | S2 | S3 | S4 | S5 | S6 |
|---|---|---|---|---|---|---|---|---|---|
| FIG. 10 (6-sector) | X | X | X | 0 | 0 | 0 | 0 | 0 | 0 |
| FIG. 11 (6-sector) | X | | X | 0 | 0 | 0 | 0 | 0 | 0 |
| FIG. 11 (6-sector) | | X | | 30 | 30 | 30 | 30 | 30 | 30 |
| FIG. 12 (6-sector) | X | X | X | 15 | 15 | 15 | 15 | 15 | 15 |
| FIG. 13 (6 & 3) | X | | | 0 | 0 | 0 | 0 | 0 | 0 |
| FIG. 13 (6 & 3) | | | X | 30 | S | 30 | S | 30 | S |
| FIG. 13 (6 & 3) | | X | | 30 | 30 | 30 | 30 | 30 | 30 |
| FIG. 9 (3-sector) | X | X | X | 30 | S | 30 | S | 30 | S |
| FIG. 15 (2-sector) | X | | | 0 | S | 60 | S | S | S |
| FIG. 15 (2-sector) | | X | | 60 | S | S | S | 0 | S |
| FIG. 15 (2-sector) | | | X | S | S | 0 | S | 60 | S |

When proceeding sequentially from 6 to 3 to 2 sectors, the maximum total rotation of the horizontal beamwidth of any antenna is 60 degrees. The half power beamwidth is correspondingly increased from 33 degrees to 120 degrees. For example, at least one of the KMW antennas has an adjustable horizontal beam direction of ±30 degrees (i.e., 60 degrees in total) and a beamwidth adjustable from 33 degrees to 120 degrees with intermediate steps of 65 degrees (optimal for 3-sectors) and 90 degrees. One practical example deployment mounts the antenna so that when the adjustable beam direction is set to zero degrees, the beam points at 30 degrees to the radial line. This allows the complete set of rotations which vary between 0 and 60 degrees.

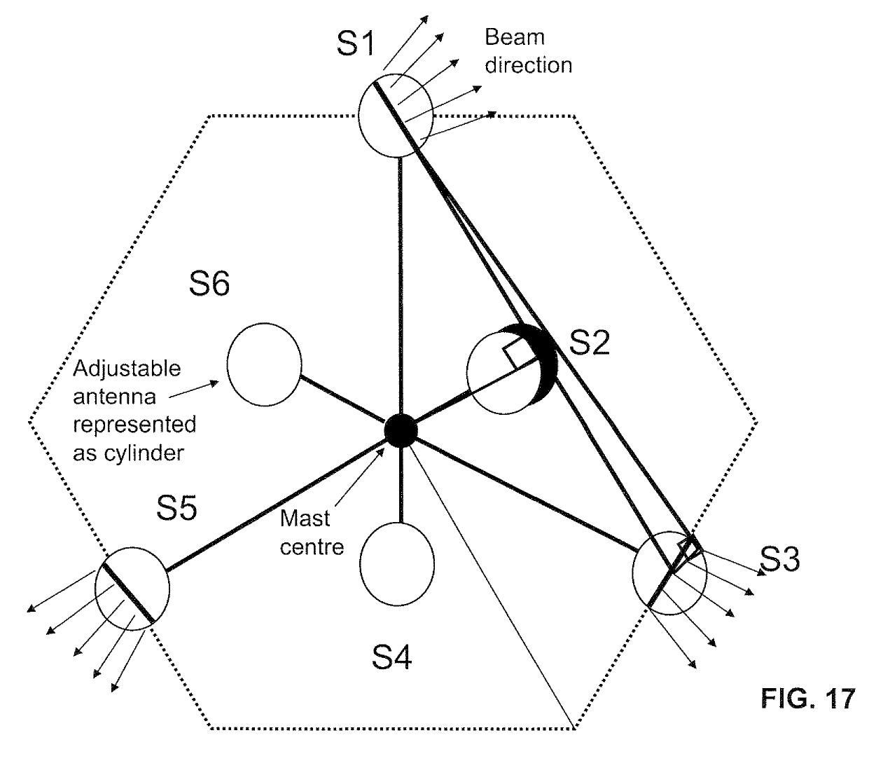

In the two-sector configuration in the above rotation table, one sector is rotated 60 degrees and has a beamwidth of 120 degrees. A method to avoid the radiated pattern from being disturbed by the other antennas is provided in FIG. 17. Every second antenna is positioned closer to the mast. This allows the antennas further from the mast a wider angle to fully radiate. This method is only needed when the original starting point had six sector antennas and the final configuration has two sectors.

### Other Compensation Measures to Adjust for Coverage Loss

When sectors are shutdown in large parts of the network to reduce power consumption, one or more of the following methods may be are used to compensate for the reduced coverage far from the base stations. One method is to correlate the number of sectors shutdown with the traffic in the network. More sectors can be shutdown if the traffic load is lower, for example during night-time or non-busy hour periods. This method is especially suitable for technologies such as WCDMA, HSPA, CDMA which share the same carrier frequency between multiple users. Less traffic generates less interference, which reduces the noise rise. Since coverage is dependent upon the signal to noise ratio, the reduced noise compensates to some extent for the lower signal strength. The amount of compensation depends upon the reduction in traffic load.

All channels will see the combined intra-cell interference of all users in the widened sector. As a non-limiting example, if originally there was a 75% load in each of two sectors and during low traffic there was a 40% load in one widened sector, the difference in uplink noise rise is 6-2.2=3.8 dB. This is larger than the reduction in antenna gain of 3 dB when reconfiguring a 6-sector network to a 3-sector network. On the downlink, the effect of reduced intra-cell interference depends upon the multipath propagation which introduces non-orthogonality, and on the receiver's ability to cancel this. Far from the base station, the thermal noise floor is also important. Here, interference from other base stations is normally substantial but will be reduced due to lower antenna gain and reduced traffic load.

In a non-limiting GSM application, a reduction of traffic also reduces the co-channel interference and hence the noise rise at the cell border. However, widened sectors affect frequency planning, which is also important for co-channel interference reduction. The frequency planning for a broadcast channel (BCCH) needs to account for widened sectors so that after sector shutdown, adjacent coverage regions still have their respective BCCHs on different frequencies. This aids in cell selection and minimizes co-channel interference between traffic channels sharing the same transceiver as the BCCH. In order to minimize disturbances in a GSM network during the process of shutting down sectors, the widened sectors must keep the BCCH on the same frequency. The original BCCH frequency planning then must take into account both the starting and modified cell plan.

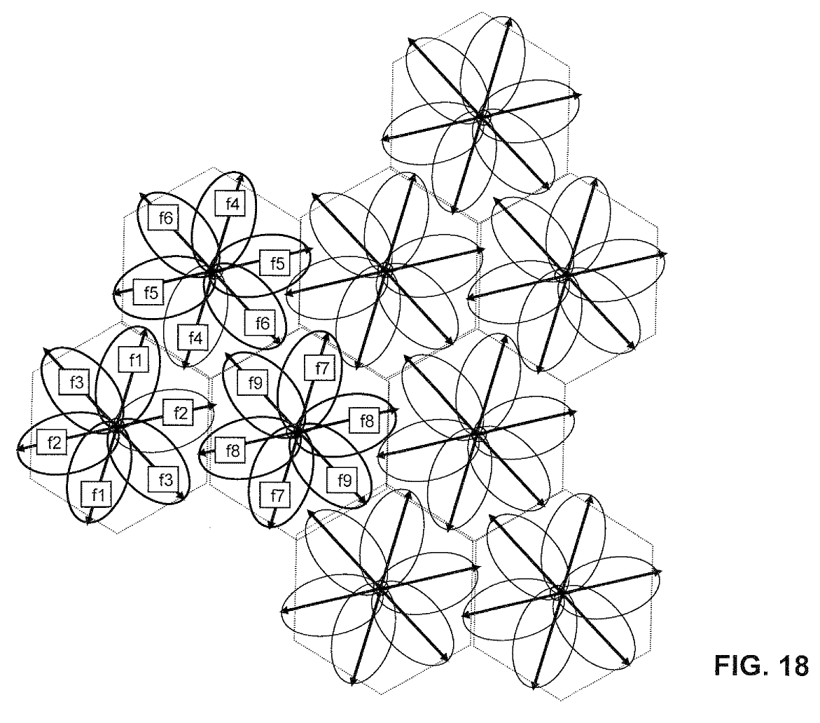

Consider as an example proceeding from 6 to 3 sectors as in FIG. 9. Each sector in a 6-sector base station has five nearest neighbors for which the BCCH must be on a different frequency. After shutdown, there are six nearest neighbors. Two of the sectors are nearest neighbors both before and after the shutdown. One solution is to allocate BCCH frequencies in the starting configuration according to FIG. 18 which shows a non-limiting example of BCCH planning for a 6-sector configuration. By allocating the same frequency to two sectors pointing in opposite directions in the same base station, a reuse pattern requiring nine BCCH frequencies repeated over groups of three base stations can be obtained. Nine BCCH frequencies still allow nine frequencies for hopping in a narrow 3.6 MHz spectrum allocation. Shutdown of sectors to the 3-sector case removes the duplicated BCCH frequency sectors leaving a suitable pattern for 3-sector sites.

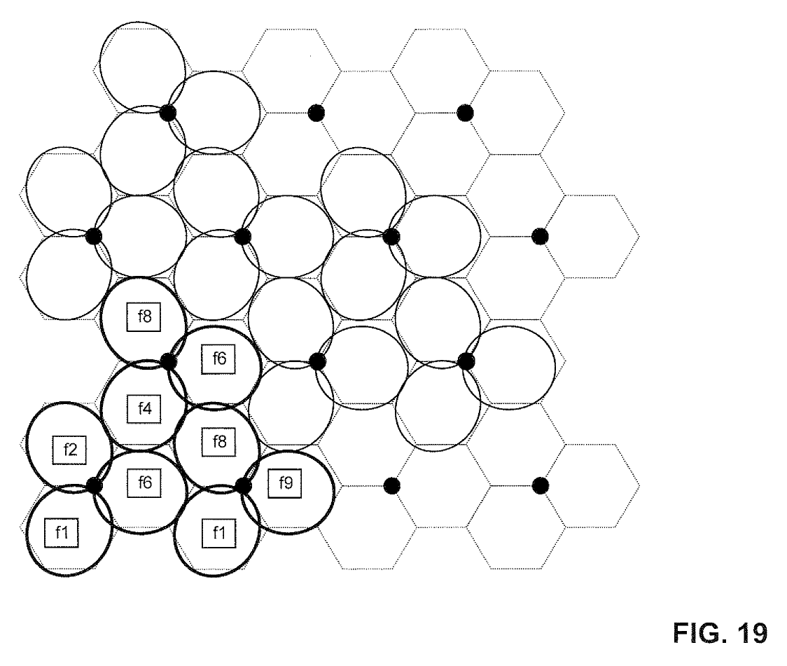

Consider as another example proceeding from 3 to 2 sectors as in FIG. 19. BCCH deployment using nine frequencies placed in repeating groups of three base stations avoids using the same frequency for a nearest neighbor's BCCH. If only 6 BCCH frequencies are available, then avoiding the nearest neighbor BCCH on the same frequency is possible using the allocation in FIG. 19. Hence, in a preferred example embodiment, 9 BCCH frequencies are used when starting with six sectors, and 6 BCCH frequencies are used when starting with three sectors.

In a low traffic situation, it is expected that all or most of the traffic can be supported using the same transceiver that transmits a BCCH. Operating a single transceiver in a widened sector will normally give the lowest power consumption. However, since the BCCH cannot use frequency hopping, this means frequency hopping is not possible for the remaining traffic. In some implementations, multiple GSM frequencies are served by a single radio equipment, either with a multiple carrier power amplifier (MCPA) or multiple TX amplifiers. In these cases, power consumption is typically lower when having a single radio equipment operating on two frequencies in a widened sector compared to having two radio equipments operating in separate sectors each using one frequency. The saving is larger for an MCPA than for multiple TX amplifiers. The saving is also larger when there is sufficient traffic so that the traffic requires two frequencies in a widened sector, rather than fitting entirely onto the BCCH frequency. Here, frequency hopping may be used, and with two frequencies in use, the best gain is if as much of the traffic is located on the non-BCCH frequency, which can hop. Note that an MCPA will limit what hopping frequencies are available due to its instantaneous bandwidth. A random hopping sequence will be simplest considering the changed cell plan when shutting down sectors.

Up-tilting is a second method that may be used to compensate for the reduced antenna gain. The vertical down-tilt of the widened antennas may be reduced so that the center of the vertical antenna beam direction points farther away from the base station. The goal is to increase the relative antenna gain far from the base station in order to compensate for coverage loss there, while allowing it to decrease closer to the base station where the shorter distance implies lower path loss. The amount of increased antenna gain far from the base station will depend upon the starting down-tilt together with the ratio of the angle of up-tilt compared to the vertical half power beamwidth of the antenna.

To quantify the effect of up-tilting, an illustrative (but non-limiting) example in an urban environment is used, where the original coverage stretched 700 m from the base station, the antenna height is 30 m, the vertical half power beamwidth is 7 degrees, and the starting down-tilt is set to 5 degrees. The center of the antenna beam points roughly 340 m from the base station, and at 700 m, the angle from the beam center is approximately 2.5 degrees. Up-tilting 2.5 degrees will increase the antenna gain at 700 m by roughly 2 dB, and decrease it at 340 m by roughly 2 dB.

A third compensation method includes adjusting transmit output power. Many systems often have automatic power control, at least for the dedicated channels. Assume before reconfiguration that the traffic has reduced to a lower level. The lower interference reduces the average output power of the adjustable channels. During the reconfiguration process, traffic will move from shutdown sectors to widened sectors. This process is preferably accompanied by automatic adjustments in the transmit output power allocated to the dedicated channels. On average, the allocated transmit output power needs to rise after reconfiguration, assuming constant traffic load, to compensate for the lower antenna gain. Terminals located at specific points with poorest relative coverage after reconfiguration should receive the largest relative increase in output power. The adjustments may be affected by up-tilting. Increasing the output power by 1 dB to handle traffic for a terminal far from the base station is more difficult and has a larger total impact than a 1 dB increase for a terminal closer to the base station, so up-tilting, where possible, will have a positive impact on the total output power required.

The reconfiguration may be accompanied by a command to adjust the output power allocated to channels such as pilot and common channels, which are not subject to automatic power control. Increasing the output power of the all the downlink channels will help compensate for the coverage loss, with the greatest gain in the case where there was least gain from reduced traffic load.

While reconfiguration at constant traffic load increases the average output power and therefore power consumption per radio equipment, typical radio equipment has highest efficiency at maximum output power, so one radio equipment operating at a given output power consumes considerably less power than two radio equipments each operating at half the output power.

As a fourth compensation method, the bit rate of the dedicated channel may be reduced when the required increase in output power for a channel exceeds that which is available. This additional safety mechanism retains coverage but at lower performance.

Using one or more of the four methods to compensate for reduced antenna gain during shutdown of sectors (correlating the number of shutdown sectors with traffic load, up-tilting, adjusted output power, and reduced bit rate) to retains close to if not full coverage. Alternatively, an operator may decide to prioritize power consumption during some periods by shutting down additional sectors, allowing for a reduction in coverage. Using the sequence of cell plans, there are several intermediate steps which can be chosen.

### Non-Homogenous Modifications

Local exceptions to the cell plans described above may be employed to cater for the non-homogenous nature of real network deployments. During traditional low-traffic periods, there may be some hot spots, i.e., some base stations with high traffic. For these base stations, no or fewer sectors are shutdown. The width and rotation of sectors may be altered (within the bounds of the adjustability of the antennas and the antenna arrangement in the mast) to focus radio resources to a particular region. Up-tilting in the surrounding base stations may be reduced to either minimize interference or increased to offload some of the subscribers.

Terrain variations, local variations in subscriber density and access to sites may lead to deviations from the classical hexagonal pattern. The sequences of cell plans are then locally modified with the net result being a given percentage of shutdown sectors in the network correlated to the traffic load.

### Minimizing Dropped Calls During Shutdown

Dropped calls during shutdown may be reduced by adjusting the radio equipment and antenna subsystems of the sectors to cover their widened geographical areas before shutting down sectors. Otherwise, traffic would be lost when sectors are shutdown due to coverage holes. During the time between the widening of some sectors and the shutdown of the other sectors there may be a temporary coverage overlap. Handover of connections from the to-be-shutdown sectors is then ordered, preferably swiftly as the overlap causes interference that affects the existing connections. Handover may be orchestrated via commands from a network operation center. Alternatively, it can be forced by increasing the power of the channel used for handover measurements in the widened sectors and decreasing power in the sectors to be shut down. Shutdown proceeds after a certain percentage (100% or less) of handovers is completed. To alleviate interference problems during the overlap period, bit rates of existing data users may be temporarily reduced. Although handover relations between neighboring cells are affected by shutting down sectors, redefining handover relations when shutting down sectors can be avoided by including more neighbors in the set of allowed handovers.

### Return to Normal

At some point, when it is desirable to bring back on-line powered-down sectors, the sector equipment is returned to its full capacity configuration. Any compensating factors like output power settings, vertical tilt, cell planning, etc. are restored to the desired state for full capacity operation. This may be done successively, i.e., moving back up the sequence of shutdown cell plans.

### Power Savings Calculations

The technology in this application enables shutting down multiple s e t s of radio equipment in one or more sectors in multiple base stations to reduce network power consumption, while retaining the additional benefits by having the multiple sets of radio equipment in non-shutdown sectors still in operation. For example, shutting down three sectors in a 6-sector site reduces the power consumption of the base station site by approximately 30-40%. This reduction assumes that radio equipment accounts for 80% of power consumption in a 6-sector base station while digital equipment (which is not shutdown) 20%. The 40% reduction is if the output power of the channels after reconfiguration is the same as before reconfiguration. The 30% reduction is a typical figure if the output power of the channels after reconfiguration is double that compared to before reconfiguration. If a low traffic sector configuration is operated for example 12 hours/day, then the total annual energy consumption is reduced 15-20%. For a typical 6-sector WCDMA site with average power consumption of 2 kW, this is roughly a savings of 2600-3500 kWh/year. Shutting down one sector in a 3-sector site saves approximately 16-26% power consumption during a low traffic sector configuration, which corresponds to 8-13% on the annual energy consumption. A 3-sector site may use 1.2 kW , which means a power savings of about 1000-1500 kWh/year. Reconfiguring from 6-sectors to 2-sectors reduces power consumption during shutdown of 36-53%, which translates to an annual energy savings of 18-26%. Reconfiguring from two sectors to an omni configuration reduces power consumption even more. Similar reductions can be expected in other systems assuming a similar efficiency versus output power characteristic of power amplifiers. Even further reductions can be obtained if there are multiple digital parts required to serve a base station with multiple sectors, and some of these can be shutdown when a number of sectors are shutdown. This technology is also useful for sites powered by solar power, as the radio base station energy use will drop significantly during night-time, when it is not possible to produce electricity from the sun.

When there are power outages, coverage can still be provided with multiple shutdown sectors in the radio network extending the time that installed battery-back-up systems can power the base station. This power saving mode (shutdown of equipment) may also be used to prolong the lifetime of some components that fail after a given number of hours in operation.

### Antenna Placement Close to the Mast

In FIG. 17, the antennas are positioned to allow free radiation into a wider angle for antennas with high rotation and wide beamwidths. To reduce visual impact, the antennas may be placed close to the center of the mast, either as in the example in FIG. 17, or all at the same distance from the mast (if proceeding from six to three sectors or from three to two sectors). The angle of free radiation depends upon the distance from the mast and the size of the antennas.

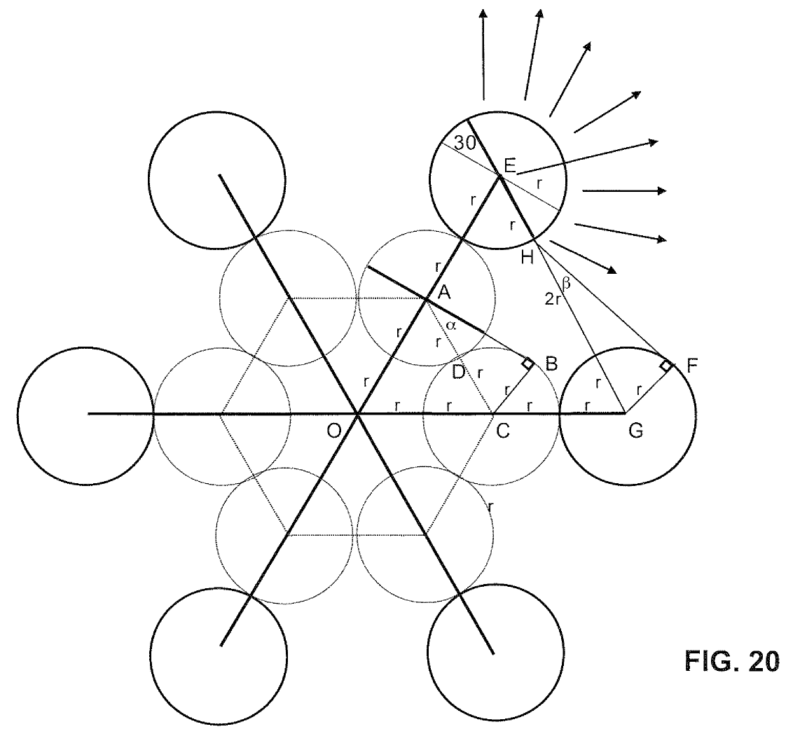

FIG. 20 shows six adjustable antennas, each antenna is in this non-limiting example in the form of a cylinder with radius r (e.g., r is about 12.8 cm in an adjustable antenna sold by KMW Inc). The antennas are placed symmetrically with centers 4 r from the center of the mast. When one antenna is rotated 30 degrees, (e.g., when shutting down three sectors), the angle of free radiation from the center of the antenna beam to the most obstructing neighbor antenna is given by 90-β degrees. From the triangle FGH, sin β=⅓, and β is approximately 19.5 degrees. More generally, when the antennas are placed a distance nr from the center of the mast, sin β=1/(n−1). A minimum physical distance is when n=2, and while the free angle of radiation is 90 degrees if there is no rotation, (the line AB is perpendicular to the line OA), it is zero degrees for when the antenna is rotated 30 degrees (the antennas touch at point D).

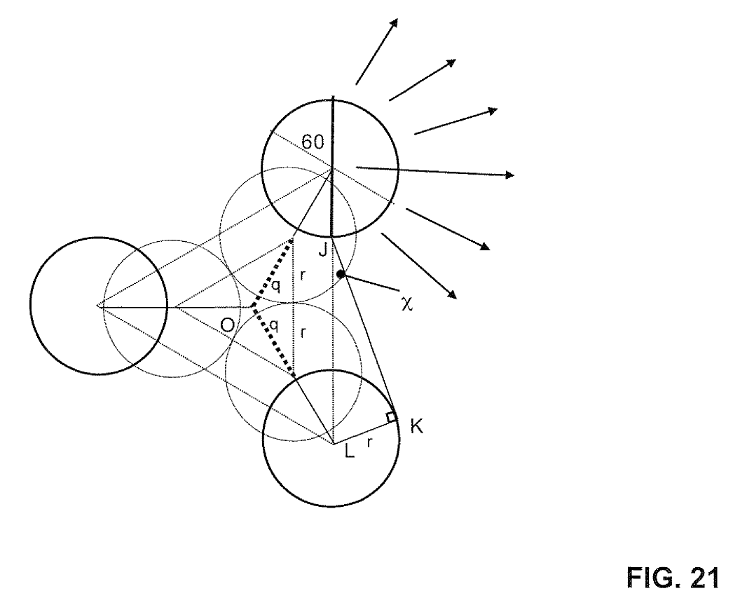

When starting with three sectors, the angle of free radiation can be calculated using FIG. 21. With antennas placed with their centers nq from the center of the mast, where q is the minimum physical distance, an antenna rotated at 60 degrees (e.g., when proceeding from 6 to 3 to 2 sectors) has a free angle of radiation given by 90-χ degrees, where sin χ=1/(2n−1).

When starting with six sectors and proceeding via three sectors to two sectors, if the antennas in FIG. 17 closest to the mast center are placed at the minimum possible distance q=2r/sqrt(3), the outer three antennas may be placed at the distance nr, where nr sin 30=q+r or n=2(2/sqrt(3)+1), calculated with S2 placed as the white (not the black) circle. Continuing with the non-limiting example of the KMW antenna with r˜12.8 cm, the outer three antennas in FIG. 17 can be placed with centers approximately 55.2 cm from the mast center, which does not lead to more visual impact than typical multi-sector antenna placements. Antenna placement as in FIG. 17 reduces the angle of free radiation for the antennas closest to the mast. In FIG. 10, all antennas radiate directly outwards, i.e., have zero rotation. With zero rotation, the closest antennas in FIG. 17 have an angle of free radiation of 90-2 φ degrees, where sin φ=1/(sqrt(3)n/2−1). For n as above, φ˜21.5 degrees, so the angle of free radiation is roughly 47 degrees. Since the closest antennas are only used with narrow 6-sector beams, this angle is sufficiently large. When the 6-sector starting configuration has beam directions rotated away from the hexagon vertices (as in FIG. 11 or FIG. 12), the placement of the antennas may be rotated by the same angle i.e., a line from the mast centre through the antenna centre points in the starting configuration beam direction, rather than towards the cell plan hexagonal vertices. This corresponds to rotating the mounting supports in FIG. 6 by 15 degrees, so that both the mounting supports and the 6-sector antenna beam directions point at an angle of 15 degrees from the hexagon vertices. The same angle of free radiation for the closest antennas as for FIG. 10 is then obtained. Rotating the mounting supports for the starting configurations in FIG. 11 and FIG. 12 also provides a larger free angle once sectors are shutdown. This is because the maximum relative rotation of a single antenna proceeding from six to two sectors is 60 degrees starting from FIG. 10, but less than this starting from FIG. 11 or FIG. 12. Even with antennas placed at minimal distance from the mast center, the relative rotation of neighboring active antennas in the configurations detailed is low enough to retain sufficient isolation, which in one non-limiting example may be at least 30 dB.

### Failure Mode

Sectors may be shutdown due to failure, maintenance, or upgrade, which may occur during high traffic and low traffic situations. In the event of a failure in a sector or a planned shutdown to perform maintenance, testing, or upgrade, the goal is to minimize the number of affected subscribers ordinarily served by the base station. If only a single sector is shutdown, only a limited number of nearby sectors need to be adjusted to compensate for the loss of coverage, rather than changing the cell plan of the entire network.

At a very minimum, if a sector containing a single radio equipment is shut down, then a single adjacent sector may have its antenna beamwidth doubled and its horizontal beam direction rotated to cover both its own coverage area and the coverage area of the shutdown sector. Each sector normally has several nearest neighbor sectors. By adjusting multiple nearest neighbor sectors, the extra load on each adjusted sector can be reduced compared to that placed on a single adjusted sector. In typical networks, a symmetric adjustment of multiple sectors usually distributes coverage evenly. Preferably, at least the two adjacent sector antennas on either side of the shutdown sector are adjusted by rotating their beam directions towards the shutdown sector area along with a widening of their horizontal beamwidths (assuming there are originally three or more sectors).

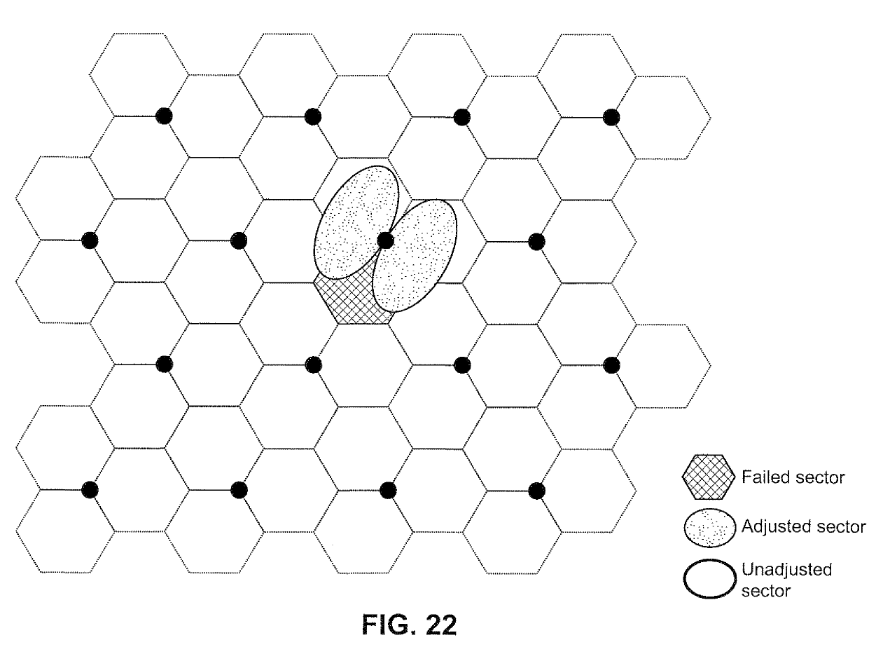

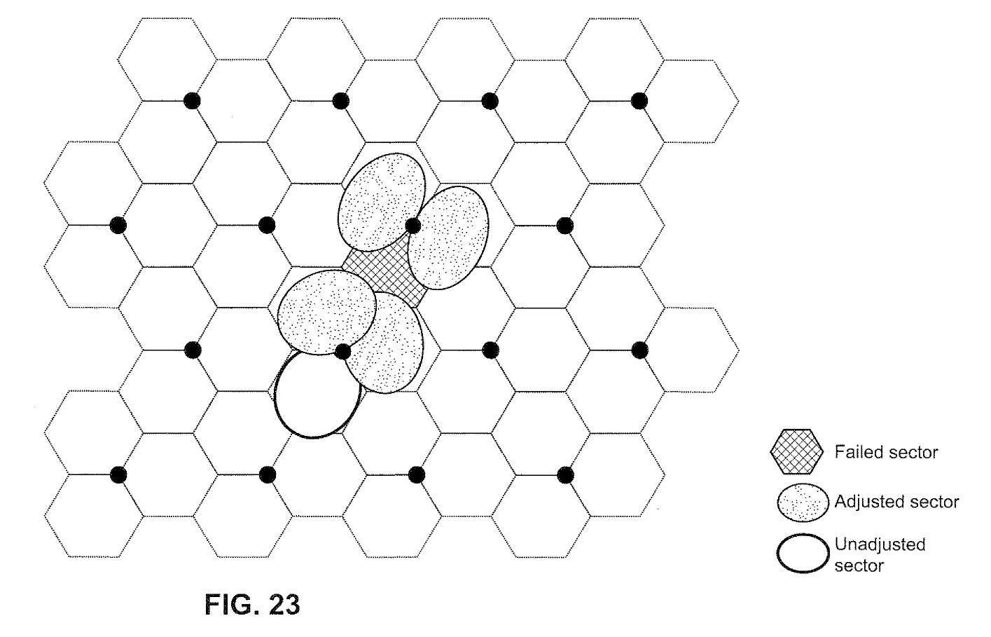

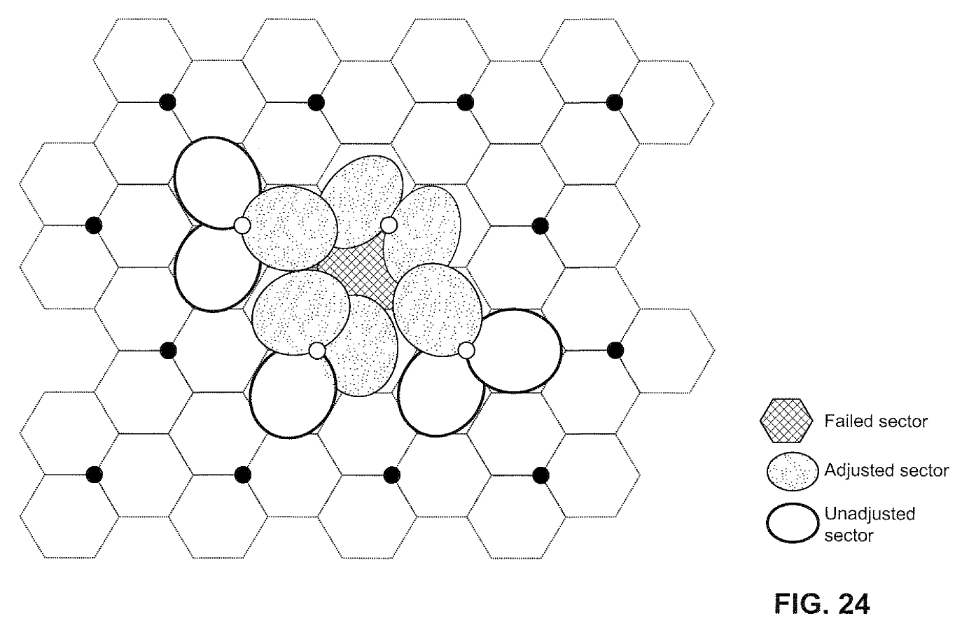

As an example, consider a regular hexagonal pattern of 3-sector base stations with a single shutdown sector belonging to one base station. If a single adjacent sector is rotated and its beamwidth doubled, then the beam direction will point directly towards an antenna beam coming from a neighboring base station resulting in interference, which implies areas of less coverage elsewhere. The required rotation is also substantial, in this case being 60 degrees. It is preferable to rotate the two adjacent sectors, as illustrated in FIG. 22. Each widened sector is required to cover one and a half original sectors, which is less than the case of a single adjusted sector that would have to cover two original sectors. In the hexagonal geometry of 3-sector sites, each sector has six nearest neighbors. FIG. 23 adjusts four of the six nearest neighbor sectors by rotating the antennas in each case towards the shutdown sector and widening beamwidths of the rotated antennas. The difference between FIG. 22 and FIG. 23 is that the area furthest from the base station in the shutdown sector is better covered. This also allows a smaller rotation of the two sector antennas belonging to the base station with the shutdown sector. In FIG. 23, each widened sector is required to cover less than one and a half original sectors. In FIG. 24 illustrating an example adjustment of six sectors, all six nearest neighbor sector antennas are rotated towards the shutdown sector along with widened beamwidths. The additional load on each widened sector is minimized even further.

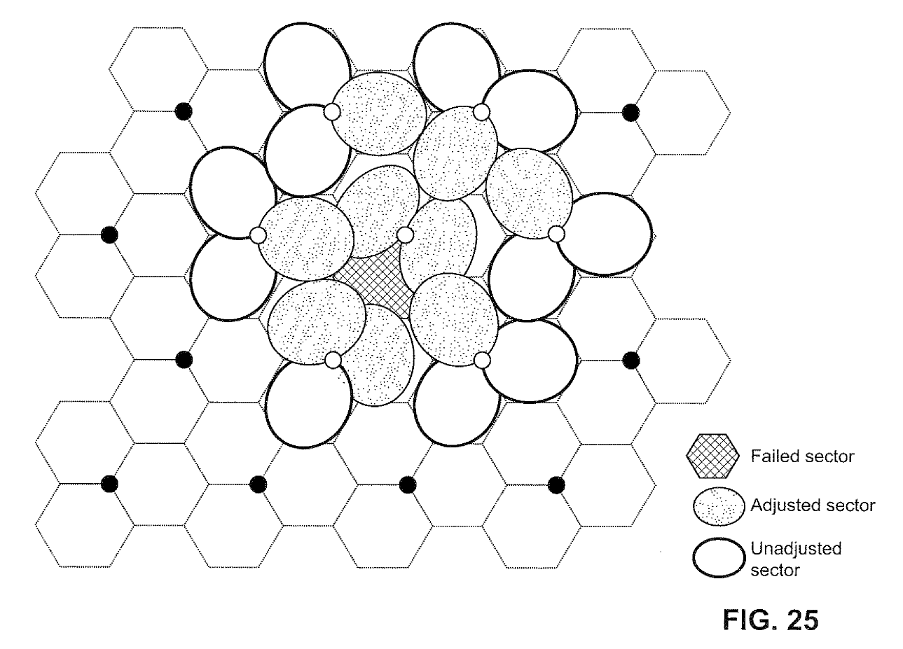

FIG. 25 shows an example reconfiguration where not only are six nearest neighbor sectors rotated towards the shutdown sector, but three additional sectors are adjusted to compensate for the rotation of two of the sectors. Two of these three additional sectors are rotated, while the middle sector is narrowed. This pattern of adjustments could be continued further from the shutdown sector, with each successive adjustment being smaller (as each adjustment is a partial compensation).

The adjustments described may be accompanied by, where necessary or desired, vertical tilt adjustments as well.

Dropped calls may be avoided by ordering handover for ongoing calls that might be affected from the sector being shutdown to the relevant sector taking over coverage. Normally, the relevant sector is identified as the nearest neighbor sector with a best pilot signal strength at the user's location. Avoiding dropped calls also means that, for a GSM example application, the BCCH frequency of each adjusted sector is retained. This will be the case for 3-sector base stations if 9 BCCH frequencies are used. Frequency hopping may then be used as normal in the widened sectors to minimize co-channel interference. Random frequency hopping will be simpler to implement; otherwise, an algorithm to find optimal hopping sequences both when all sectors are in operation and when any single sector is shutdown is required.

Because a radio network often contains thousands of sectors, it is possible that there are multiple isolated failures at any one time, normally located randomly in the network. If two failures are several base stations apart, the failure mode method described may be separately applied to each shutdown sector and its nearest surroundings. If two failures are close together, then there may be sectors located between the two shutdown sectors with areas to be covered on either side so that only a beam widening for these sectors may be appropriate. It may also mean that more of the load must be taken by neighboring sectors surrounding the region containing the two shutdown sectors.

The cost savings due to reduced downtime varies from site to site and when during the day the failure occurred. But a key advantage is having the ability to provide service in the geographical area covered by all original sectors notwithstanding.

Although various embodiments have been shown and described in detail, the claims are not limited to any particular embodiment or example. For examples although six-to-three and three-to-two sector base station reconfiguration examples have been described, any number of sectors may be reconfigured to some smaller number of sectors. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. Radio base station and antenna system apparatus comprising:
a first sector configured to provide coverage for a first sector area and having first radio equipment connected to a first antenna with variable horizontal beamwidth and variable horizontal beam direction;
a second sector configured to provide coverage for a second sector area and having second radio equipment connected to a second antenna with variable horizontal beamwidth and variable horizontal beam direction; and
control circuitry configured to detect an indication to reconfigure the base station and antenna apparatus from a first base station configuration to a second base station configuration, and in response thereto, to adjust the horizontal beamwidth and horizontal beam direction of the first antenna to provide coverage both for the first sector area and for the second sector area.

2. The radio base station and antenna system apparatus in claim 1, wherein the control circuitry is configured to detect a need to reconfigure the base station apparatus from the second base station configuration to the first base station configuration, and in response thereto, to adjust the horizontal beamwidth and horizontal beam direction of the first antenna to provide coverage for the first sector area and to activate the second radio equipment and second antenna to provide coverage for the second sector area.

3. The radio base station apparatus in claim 1, wherein the control circuitry is configured to power-down the second sector radio equipment in order to save power when the horizontal beamwidth and horizontal beam direction of first antenna is adjusted to provide coverage both for the first sector area and for the second sector area.

4. The radio base station and antenna system apparatus in claim 1, wherein the first antenna is an antenna having a variable tilt of a vertical antenna beam direction, and
the control circuitry is configured to adjust the variable tilt of the vertical antenna beam direction to provide coverage both for the first sector area and for the second sector area.

5. The radio base station and antenna system apparatus in claim 1, wherein the control circuitry is configured in the second base station configuration to adjust a performance characteristic of the first radio equipment in the first base station in order to compensate for reduced antenna gain in the second base station configuration as compared to the first base station configuration.

6. The radio base station and antenna system apparatus in claim 1, wherein the control circuitry is configured to detect a predetermined condition or parameter indicating a need or request for reconfiguring the base station apparatus.

7. The radio base station and antenna system apparatus in claim 6, wherein the predetermined condition or parameter is a time, a sector traffic load, or a radio condition.

8. The radio base station and antenna system apparatus in claim 6, wherein the predetermined condition or parameter is a malfunction, maintenance, or upgrade affecting the second sector.

9. The radio base station and antenna system apparatus in claim 6, wherein the predetermined condition or parameter is a signal received from a supervisory node external to the base station.

10. The radio base station and antenna system apparatus in claim 1, wherein the radio base station and antenna system apparatus includes additional multiple sectors, each configured to provide coverage for an additional sector area and each having one or more sets of radio equipment connected to an antenna having variable horizontal beamwidth and having variable horizontal beam direction, the control circuitry being configured in response to the indication to reconfigure the base station and antenna system apparatus from a first base station configuration to a second base station configuration by adjusting the horizontal beamwidth and horizontal beam direction of one or more antennas for one or more additional sectors to provide coverage in one or more of the additional sector areas.

11. The radio base station and antenna system apparatus in claim 10, wherein:
the base station is one of multiple base stations belonging to a radio network, and
the first configuration is associated with a first cell plan of the radio network and the second configuration is associated with a second cell plan of the radio network.

12. The radio base station and antenna system apparatus in claim 11, wherein:
there is a sequence of base station configurations associated with a sequence of cell plans of the radio network, and
each successive cell plan in the sequence of cell plans has a higher number of radio equipments shut down with some or all remaining active antennas adjusted to together provide coverage for both their original sector areas and one or more neighboring areas belonging to sectors that have been shut down.

13. The radio base station and antenna system apparatus in claim 12, wherein:
each cell plan includes antennas directed to cover a geographical area and to reduce interference between sectors, and
each successive cell plan in the sequence of cell plans is obtainable from a previous cell plan in the sequence of cell plans by adjusting sector antennas by rotating sector antennas by 30 degrees or less.

14. The radio base station and antenna system apparatus in claim 13, wherein the radio base stations use GSM technology and the first cell plan is associated with broadcast channel (BCCH) frequency planning and avoids using the same BCCH frequency for nearest neighbor sectors throughout the sequence of cell plans.

15. The radio base station and antenna system apparatus in claim 10, further comprising six adjustable antennas mounted at the same height on a mast or tower with every second antenna being located closer to the mast or tower.

16. The radio base station and antenna system apparatus in claim 10, wherein all sector antennas are placed at or below a given height on a mast or tower and an omni antenna is placed at the top of the mast or tower, and further comprising a switch for controllably connecting one radio equipment in the base station to the omni antenna when a signal is received to shut down all other radio equipments in the base station.

17. A method for use in a radio base station and antenna system apparatus having a first sector configured to provide coverage for a first sector area and having first radio communications equipment connected to a first antenna with variable horizontal beamwidth and variable horizontal beam direction and a second sector configured to provide coverage for a second sector area and having second radio communications equipment connected to a second antenna with variable horizontal beamwidth and variable horizontal beam direction, comprising:
detecting an indication to reconfigure the base station and antenna apparatus from a first base station configuration to a second base station configuration, and
in response thereto, adjusting the horizontal beamwidth and horizontal beam direction of the first antenna to provide coverage both for the first sector area and for the second sector area.

18. The method in claim 17, further comprising:
detecting a need to reconfigure the base station apparatus from the second base station configuration to the first base station configuration, and
in response thereto, adjusting the horizontal beamwidth and horizontal beam direction of the first antenna to provide coverage for the first sector area and to activate the second radio equipment and second antenna to provide coverage for the second sector area.

19. The method in claim 17, further comprising:
powering-down the second sector radio equipment in order to save power when the horizontal beamwidth and horizontal beam direction of first antenna is adjusted to provide coverage both for the first sector area and for the second sector area.

20. The method in claim 17, wherein the first antenna is an antenna having a variable tilt of a vertical antenna beam direction, the method further comprising:
adjusting the variable tilt of the vertical antenna beam direction to provide coverage both for the first sector area and for the second sector area,

21. The method in claim 17, wherein in the second base station configuration, adjusting a performance characteristic of the first radio equipment in the first base station in order to compensate for reduced antenna gain in the second base station configuration as compared to the first base station configuration.

22. The method in claim 17, further comprising adjusting the horizontal beam direction of one more or antennas of neighboring sectors.

23. The method in claim 17, further comprising detect a predetermined condition or parameter indicating a need or request for reconfiguring the base station apparatus

24. The method in claim 17, wherein the predetermined condition or parameter is a time, a sector traffic load, a radio condition, a malfunction, maintenance, or upgrade affecting the second sector.

25. A cell planning method for use in a radio network including multiple base stations where each of those base stations includes multiple sectors, each sector being configured to provide coverage for a corresponding one sector cell area and having radio communications equipment connected to a corresponding antenna with variable horizontal beamwidth and variable horizontal beam direction, where upon detecting a condition, the horizontal beamwidth and horizontal beam direction of one or more of the sector antennas is adjusted to provide coverage for additional sector cell areas, the method comprising:
establishing a first cell plan and a second cell plan for the radio network, where the second cell plan corresponds to a situation where the horizontal beamwidth and horizontal beam direction of one or more of the sector antennas is adjusted to provide coverage for at least one cell area in addition to its corresponding sector cell area.

26. The method in claim 25, further comprising:
associating a sequence of different base station configurations with a sequence of cell plans for the radio network,
wherein each successive cell plan in the sequence of cell plans has a higher number of radio equipments shut down with some or all remaining active antennas adjusted to together provide coverage for both their original sector areas and one or more neighboring areas belonging to sectors that have been shut down.

27. The method in claim 26, wherein
each cell plan in the sequence of cell plans includes antennas directed to cover a geographical area with low interference between sectors, and
each successive cell plan in the sequence of cell plans is obtainable from a previous cell plan in the sequence of cell plans by adjusting sector antennas by rotating sector antennas by 30 degrees or less.

28. The method in claim 27, wherein the radio base stations use GSM technology and the first cell plan is associated with broadcast channel (BCCH) frequency planning which avoids using the same BCCH frequency for nearest neighbor sectors throughout the sequence.
